(19) United States
(12) Patent Application Publication
(10) Pub. No.: US 2009/0120779 A1
(43) Pub. Date: May 14, 2009

(54) DEVICE FOR DESALINATION OF WATER AND INCREASING HUMIDITY

(76) Inventor: David Joseph Strain, Saint Peters, MO (US)

Correspondence Address: SPENCER, FANE, BRITT & BROWNE, 1000 WALNUT STREET, SUITE 1400, KANSAS CITY, MO, 64106-2140, US

(21) Appl. No.: 11/939,547

(22) Filed: Nov. 13, 2007

(51) Int. Cl. B01D 3/02

(52) U.S. Cl. 202/234

(57) ABSTRACT

The present invention is directed to a device for producing potable water and increasing the humidity of ambient air. The device includes a housing with an interior space and having an upper surface and an outlet. At least the upper surface of the housing is constructed from a material adapted to admit electromagnetic radiation into the interior of the housing for the purpose of heating the interior of the housing. Water within the interior of the housing is vaporized and exits the housing through the outlet.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

The lack of water is one of the most pressing issues facing the world today, and the problem is expected to grow worse in coming decades. The United Nations estimates that by the year 2050 more than two billion people in the world will lack sufficient water. While the earth has vast quantities of water, most of this water is salt water rather than fresh water. Further, much of the fresh water supply in the world is frozen in glaciers or in the polar ice caps.

As these water supplies melt due to environmental effects such as global warming, the actual overall supply of fresh water on earth may decrease. Additionally, problems of pollution associated with industrialization and continued population growth negatively affects other sources of fresh water. While the world's population and associated demand for fresh water will continue to increase, the supply of fresh water will, at best, remain static and, at worst, actually decrease.

Existing solutions to the problem of water shortages includes desalination of ocean water by a variety of methods. Unfortunately, these methods tend to require large amounts of energy. Further, expensive infrastructure and specialized equipment is also often necessary, making methods costly not only in terms of capital expenditure but in terms of both land and resource use.

Reverse osmosis, for example, accounts for a large percentage of the desalination efforts currently underway on earth. The process is typically carried out in multi-stage flash plants. Reverse osmosis plants consume a large amount of electricity in order to produce fresh water. Thus, the plants are typically located in places like the Middle East, where the abundance of cheap oil for production of electricity makes such efforts more feasible than they would be elsewhere. Even in these locations, however, the electricity production required for the desalination plant produces significant quantities of pollution.

In addition to the above, changes in the environment of the planet negatively affect weather patterns, and therefore water distribution, around the globe. Areas in which the ambient air may have previously contained a degree of humidity may be relatively drier due to these global atmospheric and climatic shifts. Returning humidity to these areas might, to some extent, replace water lost as a result of changing climates.

What is needed, therefore, is a simple, efficient, and non-polluting device for providing fresh water from salt-water or other non-potable water sources. What is further needed is an efficient, non-polluting device for generating humidity in the ambient air.

### SUMMARY OF THE INVENTION

The present invention is directed to a device for producing potable water and increasing the humidity of ambient air. The device includes a housing with an interior space and having an upper surface and an outlet. At least the upper surface of the housing is constructed from a material adapted to admit electromagnetic radiation into the interior of the housing for the purpose of heating the interior of the housing. Water within the interior of the housing is vaporized and exits the housing through the outlet.

In another aspect of the present invention, the upper surface of the housing includes three edges, and the housing includes three sidewalls extending from each of the three edges of the upper surface of the housing, respectively. The housing is substantially enclosed by the upper surface of a body of water in which the device is positioned, which acts as a bottom surface of the housing defining an interior space therein.

In still another aspect of the present invention, the device is partially submerged includes a float portion attached to the housing for maintaining the device at a desired depth within a body of water.

In still another aspect of the present invention, the device includes a condenser portion in communication with the housing via the outlet so that water vapor produced in the housing moves through the outlet and into the condenser portion, where it is condensed.

### BRIEF DESCRIPTION OF THE DRAWINGS

FIG. 1 is a schematic illustration of one embodiment of a device for desalination and humidity generation constructed in accordance with the teachings of the present invention.

FIG. 2 is a schematic illustration of an alternative embodiment of a device for desalination and humidity generation constructed in accordance with the teachings of the present invention.

FIG. 3 is a schematic illustration of a land-based embodiment of a device for desalination and humidity generation constructed in accordance with the teachings of the present invention.

### DETAILED DESCRIPTION OF THE INVENTION

The present invention is directed to a device for producing potable water from non-potable sources, as well as for increasing the ambient humidity in the immediate area of said device. The device includes generally a housing forming an enclosed area that acts as a collector of infrared or other solar energy. The housing of the device is adapted such that when the present device is situated in a body of water, a portion of the device is submerged beneath the surface of the water and the remainder of the device is present above the surface of the water. The present device is sufficiently open to allow the surface of the body of water to flow into the device so that when the device is situated in a body of water at least a portion of the surface of that body of water is contained within the housing of the device.

At least a portion of the air flow across the surface of the body of water also enters the present device, the air flow operating, along with the heat trapped within the present device, to accelerate the evaporation of water from the surface of the body of water. The heavily vaporized, or humid, air produced as a result is channeled either out of the device or to a condenser located elsewhere in the system. In essence, the present device collects the water that is ‘distilled’ off of the top surface of a mass of non-potable water, allowing the water collected to be condensed to produce potable water.

Turning now to the drawings, wherein like numerals represent like parts, the numeral 10 refers generally to a device produced in accordance with the teachings of the present invention. The device includes a housing portion 12 having an upper surface 14, a lower surface 16, a first sidewall 18, a second sidewall 20, third and fourth side walls (not shown), and a float portion 22. First sidewall 18 preferably includes an inlet portion 26, while second sidewall 20 preferably includes an outlet portion 38.

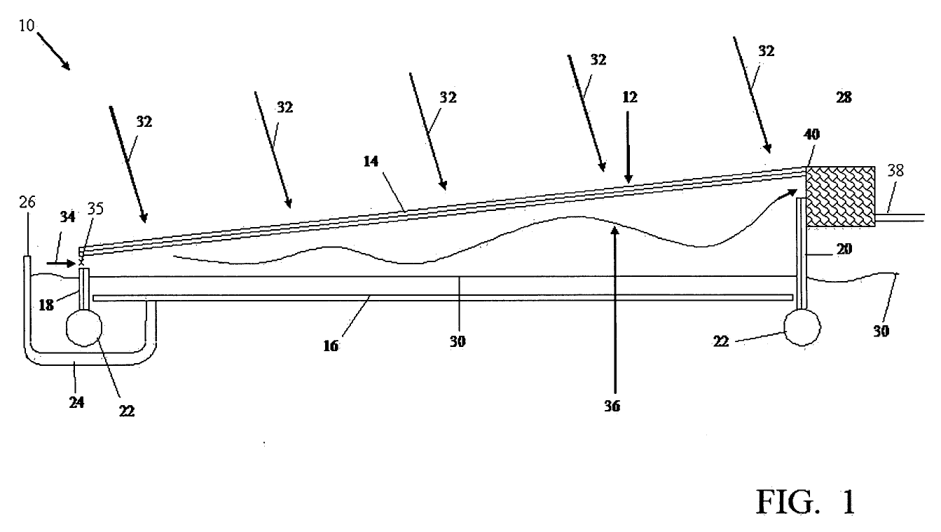

As can be seen in FIG. 1, when device 10 is placed in operable position in a body of water, a portion of the surface 30 of that body of water is contained within housing 12 of device 10. This occurs due to the fact that either lower surface 16, or one of first sidewall 18, second sidewall 20, or the third or fourth sidewalls include openings (not shown) that allow water to flow into device 10 and achieve equilibrium (in terms of the water level) with the surrounding body of water. Any or all of the sidewalls and lower surface 16 may include openings for this purpose. The water contained within device 10 is subject to greater heat levels than the water outside of device 10 due to the heat-retention action of housing 12.

Upper surface 14 of housing 12 is preferably constructed of a transparent material that will allow solar energy to enter housing 12. Upper surface 14 is further preferably glazed or otherwise treated in such a manner as to contain a maximum amount of solar energy within housing 12 of device 10. This allows a great amount of heat to be contained within device 10 as compared to the ambient environment, and allows quick heating of the water contained within housing 12 of device 10. Housing 12 of device 10 preferably includes only a few inches of water, thereby allowing rapid heating of the water.

As water is evaporated within housing 12, the humidity of the air contained therein increases significantly. This humidity represents potable water taken from the non-potable water source in which device 10 is situated. This humid air preferably exits housing 12 and enters a condenser portion 28, whereupon the water contained therein is condensed into potable liquid water. It is preferred that housing 12 is shaped in such a manner as to have an upper surface that is more greatly elevated on one side than the other, allowing the heated, humid water to rise and fill that elevated portion of housing 12. Condenser portion 28 is preferably positioned such that this humid, heated air flows naturally from housing 12, through an outlet 40 in second sidewall 20, and into condenser portion 28. Once water has been condensed from the humid air entering condenser portion 28, that water can be directed out of the present device through outlet 38, whereupon it can be directed to any desired location. Once within housing 12 of device 10, air tends to flow as indicated by directional arrow 36.

FIG. 1 illustrates two mechanisms by which air may enter housing 12 of device 10, and it is contemplated that either of these two mechanisms may be used alone, or that they may be used in combination. Ambient air may enter housing 12, for example, as indicated by arrow 34, which indicates directional air flow into housing 12 through slot 35. It is preferred that air be allowed to move through slot 35 and into housing 12 passively—that is, that device 10 itself does not actively cause such air flow. It is contemplated, however, that active air flow production may be incorporated into the present invention such as, for example, by the addition of a fan in slot 35 or just inside housing 12.

Also shown in FIG. 1 is a conduit portion 24, the conduit portion having an inlet 26 at a first end thereof. Inlet 26 is exposed to the ambient air so that the air can be drawn through inlet 26, along the length of conduit portion 24, and into housing 12 of device 10. As can be seen in FIG. 1, the air preferably enters housing 12 of device 10 beneath the surface 30 of a body of water in which device 10 is situated, thereby allowing the air to bubble up through the water and begin to acquire a degree of humidity as it does so. Movement of air through inlet 26 and along the length of conduit portion 24 may be passive, allowing ambient wind or weather conditions to push air through inlet 26 and along conduit portion 24, or may be active such as, for example, by positioning a fan at inlet 26 or elsewhere along the length of conduit portion 24. Further, air can be removed from housing 12 either by allowing the air to flow passively out of housing 12 and into condenser portion 28 or the ambient environment, or air can be actively directed out of housing 12 by, for example, the use of a fan.

As stated above, the heat contained within housing 12 of device 10 causes water within housing 12 to be vaporized, thereby increasing the heat and humidity of the air within housing 12. As shown in FIG. 1, the end of housing 12 having outlet 40 is preferably elevated relative to the high point of the end of housing 12 having slot 35 or conduit portion 24, allowing the heated, humid air within housing 12 to move naturally into the highest point within housing 12, whereupon the heated, humid air is drawn out of housing 12 and either released into the environment or directed into condenser portion 28 where potable water is condensed from the air.

Device 10, as shown in FIG. 1, also includes two float portions 22, located at opposing ends of device 10. It is preferred that at least one float portion be used in conjunction with device 10, however it is contemplated any suitable number of float portions 22 (including two or more) may be employed. The number and arrangement of float portions 22 may be varied depending on the size, weight, or other dimensions of device 10, and upon the desired buoyancy to be imparted to device 10. Any suitable float or float-like structure, or other structure capable of imparting buoyancy to device 10, may be employed for this purpose.

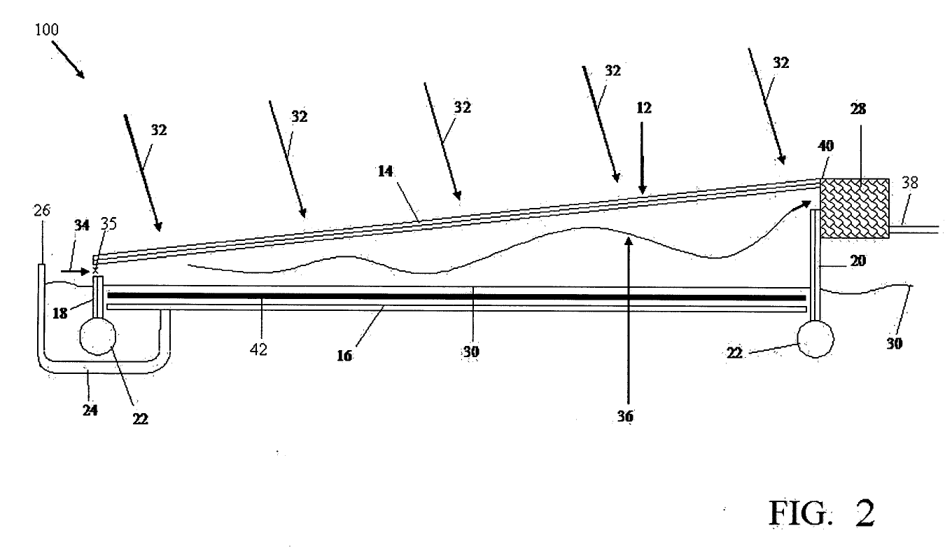

FIG. 2 provides a schematic illustration of one alternate embodiment of a device 100 constructed in accordance with the teachings of the present invention. The components of device 100 are generally substantially the same as those described with respect to device 10, and FIG. 1, above. For example, housing 12, the various sidewalls of the device, conduit portion 24, inlet 26, float portions 22, and condenser portion 28 all function substantially as described above, and various of these components of the present invention may be used or not used in a given embodiment of device 100, also as described above with respect to device 10. Device 100, however, further includes a heating portion 42, such as a heating element or hot plate, to accelerate the heating and vaporization of water contained within housing 12. Any suitable heating portion may be used, and various devices and methods for heating water are known in the art. Power may be provided to heating portion 42 in any suitable manner, such as, for example, by wind turbines associated with device 100, solar panels associated with device 100, or by use of power supplies external to device 100. The present of heating portion 42 allows more rapid vaporization and subsequent release of humid air, or condensation of potable water from the humid air produced, than is achievable by wholly passive means of heat collection and retention by device 100.

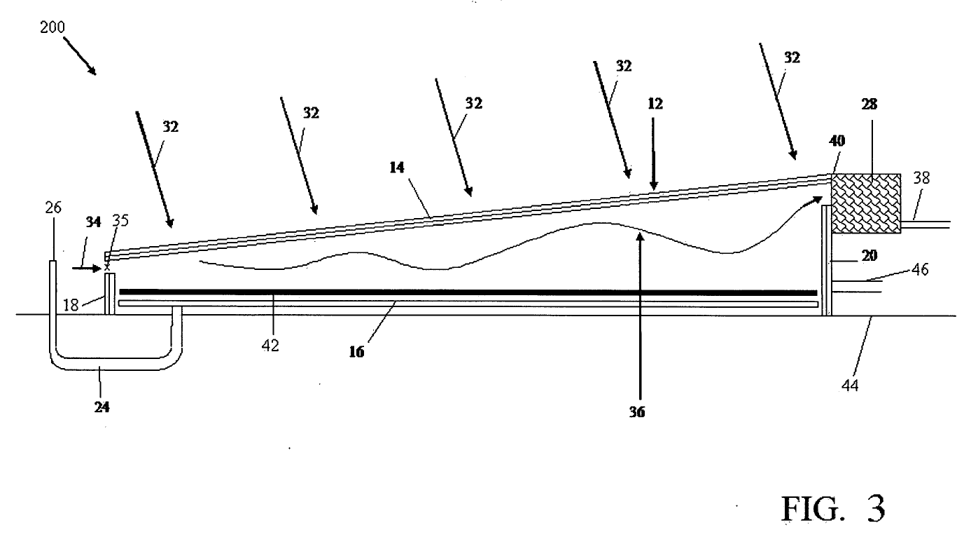

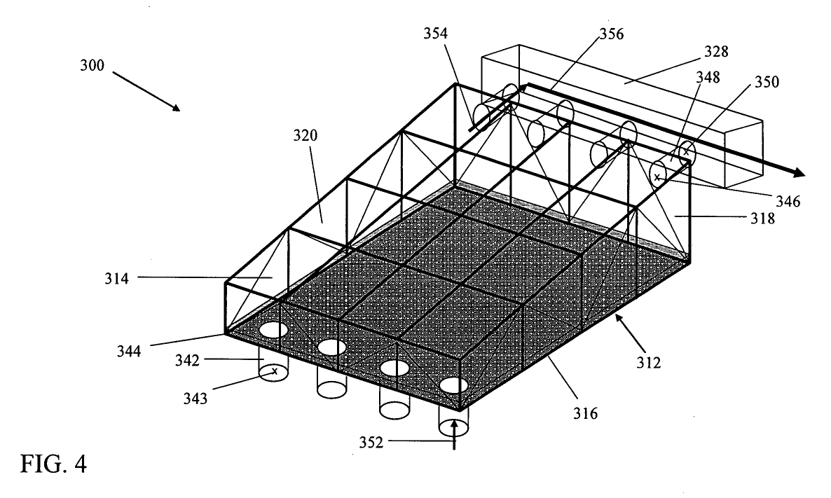

FIG. 3 provides a schematic illustration of a land-based embodiment of a device 200 constructed in accordance with the teachings of the present invention. As is described below, device 200 operates in substantially the same manner as device 10 and device 100, described above, but device 200 is adapted for use on land rather than within a body of water.

Device 200 may be situated such that it sits flat on a surface 44 of dry land, or any or all of first sidewall 18, second sidewall 20, or third and fourth sidewalls (not shown) may extend beyond a lower surface 16 of housing 12 of device 200 such that one or more sidewalls acts as a leg upon which device 200 sits and is at least partially raised from the ground.

Non-potable water may be directed into device 200 in any suitable manner. It is preferred that a conduit 46 direct non-potable water from an external source into housing 12 of device 200. Once within housing 12, the non-potable water is heated in substantially the same manner as described with respect to device 10 and device 100, above. That is, water is heated due to the heat-retention properties of housing 12 and the ability of housing 12 to collect and retain solar energy. Also, in some embodiments of device 200, as shown in FIG. 3, a heating portion such as a heating element or hot plate may be provided to more rapidly heat water contained within housing 12. Likewise, air flow into housing 12 achieved in substantially the same manner as with respect to device 10 and device 100, described above, with air flowing into housing 12 either through a slot 35, a conduit portion 24, or both. As shown in FIG. 3, at least a portion of the length of conduit portion 24 is underground, although it is contemplated that any suitable arrangement of conduit portion 24 may be utilized.

FIG. 4 provides a perspective view of one embodiment of a device 300 constructed in accordance with the principles of the present invention. Device 300 includes a housing 312 having an upper surface 314, a lower surface 316, a first sidewall 318, a second sidewall 319, a third sidewall 320, and a fourth sidewall 321. In the embodiment of device 300 shown in FIG. 4, housing 312 is constructed from a transparent material, glass or synthetic polymer for example, that admits light or other electromagnetic radiation into an interior of housing 312. The material making up housing 312 may be provided in the form of individual plates 358 that are held in place by a plurality of support portions 360 (for example, structural trusses on the sides of the device, framing and holding up plates 358, and cross carrier beams along the top surface of the device, supporting the upper plates 358). The outer surface of housing 312 may also be glazed in such a manner that once light or other electromagnetic radiation is admitted into the interior of housing 312, it is contained therein due to the reflective nature of the glaze applied to the outer surface of housing 312, thereby increasing the heat generated within housing 312. It is also contemplated that the transparent material used to construct housing 312 may be cut or otherwise modified in such a manner as to lessen the amount of light or other electromagnetic radiation that is able to escape housing 312.

Housing 312 of device 300 preferably includes at least one inlet conduit 342 and at least one outlet conduit 348, inlet conduit 342 serving to admit water into housing 312 from the body of water in which device 300 is situated, and outlet conduit 348 serving to allow water vapor produced within housing 312 to exit housing 312 and flow into condenser portion 328. In the embodiment of device 300 shown in FIG. 4, device 300 includes four inlet conduits 342 and four outlet conduits 348. As described above with respect to other embodiments of the present invention, water contained within housing 312 is vaporized due to the heat within housing 312, and the water vapor produced flows into condenser portion 328, whereupon it is condensed into water that is substantially free of salts. As can be seen from FIG. 4, the side of housing 312 having outlet conduits 348 associated therewith is elevated with respect to the side of housing 312 having inlet conduits 342 associated therewith, such that water vapor rising within housing 312 tends to flow to the elevated interior portion of housing 312 associated with outlet conduits 348, and then through conduits 348 and into condenser portion 328. Each of inlet conduits 342 has a first opening 343 through which water in the body of water in which device 300 is situated flows into inlet conduit 342, and a second opening 344 through which water flows from inlet conduit 324 into housing 312. Likewise, each of outlet conduits 348 has a first opening 346 through which water vapor from housing 312 flows into outlet conduit 348, and a second opening 350 through which water flows from outlet conduit 348 into condenser portion 328.

Non-potable water (such as water from the body of water in which device 300 is positioned) enters housing 312 of device 300 through one or more inlet conduits 342. Preferably, a relatively small volume of water, such as for example an inch or two in depth across the bottom interior of housing 312, is contained within device 300 at any given time. The volume of water contained within device 300 can be maintained or adjusted by the use of float portions 22, described above. It is contemplated, however, that any suitable method of maintaining of adjusting water volume may be employed.

Once water has entered housing 312, either through one or more inlet conduits 342 or in any other suitable manner, the water is heated by the heat contained within housing 312. In some embodiments of the present invention, a heating element (not shown) may be employed substantially along the lower interior surface of housing 312, so that in addition to or in place of heat captured from the ambient environment, the heating element serves to heat the water within housing 312 to the point of vaporization. The use of a heating element or hot plate within housing 312 accelerates the rate of vaporization of water within housing 312 and increases the efficiency of device 300. The hot plate or heating element may also be sloped to allow water flow along its length, the level of heat produced by the hot plate or heating element preferably being sufficient to substantially vaporize the water moving along its length before the water reaches the end of the hot plate or heating element. The hot, humid air created within housing 312 is drawn out of housing 312, such as through one or more outlet conduits 348, either passively (by simply allowing the flow of humid air out of housing 312), or actively such as through the use of fans or other suitable devices.

Once the hot, humid air contained within housing 312 exits housing 312, it may be vented into the ambient environment, thereby increasing the humidity thereof. It is contemplated that a plurality of devices 300 may be used in any given area to impact the ambient humidity of the area. Alternatively, the hot, humid air leaving housing 312 may enter a condenser portion 328, whereupon the water vapor is condensed in a form that contains fewer salts and other impurities than the water entering housing 312. Once the water has been condensed it may be distributed where needed in any suitable manner.

The general flow of water and water vapor through device 300 is indicated by flow arrow 352, which indicates a flow of water from a body of water into housing 312, flow arrow 354, which indicates a flow of hot, humid air from housing 312 into condenser portion 328, and flow arrow 356, which indicates a flow of water out of condenser portion 328 and away from device 300.

Air flow into housing 312 may be provided in any suitable manner, such as in the manners shown and described above with respect to other embodiments of the present invention. For example, slots in a sidewall or the upper surface of housing 312 may be provided, similar to slots 35 discussed above with respect to other embodiments of the present invention. Alternatively, a conduit portion such as conduit portion 24, described above, may be utilized. Either of the conduit portion or slots may be passive, allowing ambient wind or weather conditions to push air into housing 312 of device 300, or may be active such as, for example, by positioning a fan adjacent the slot or an opening of the conduit portion, or within the conduit portion or slot, in order to draw or push air into housing 312 of device 300.

The housings of the various embodiments of the present invention may be constructed of any combination of natural and man-made or synthetic materials that provide heat and humidity containment suitable for use with the present device. The housings should be designed to allow water and air in, and provide for movement of humid air either to a condenser portion or to be vented into the ambient environment. Further, the housing may lack a bottom surface entirely, with the body of water in which the present device is positioned acting as a bottom surface for the purpose of substantially enclosing an interior space of the housing. In such embodiments, it is contemplated that a heating element may be provided extending between two or more sidewalls of the housing, such as in a mesh arrangement for example, for the purpose of heating an defined upper volume of the body of water in which the present device is positioned.

The present device may be used in any environment having a supply of non-potable water to produce potable water therefrom. Further, the device may be scaled to any desired proportions according to the needs or limitations of a particular area in which the device is to be used, or the desires of the engineers or other individuals making use of the present device at a given location. Further, it is contemplated that multiple such devices may be used in a given location, each device providing potable water or humidity cumulative to that provided by the other such devices.

In areas in which potable water is not desired, but humidity is desired for climate-related purposes, the present device may be free-standing, included little more than the housing described above adapted for land or water use. Even used passively, the present device will release humid air into the ambient environment.

In areas in which potable water is desired, the present device may be adapted to interact with the existing infrastructure, providing potable water into existing pipelines or other structures for delivery to the local population.

The description above is provided for the purposes of illustration only, and are not to be interpreted as limiting the present invention. It is contemplated that various modifications to the present device will be readily apparent to those of skill in the art upon reading this disclosure, and that such modifications are within the spirit an scope of the present invention. The present invention is limited only by the claims that follow.

1. A device for producing potable water and increasing the humidity of ambient air, the device comprising:
a housing, said housing defining an interior space thereof and comprising an upper surface and an outlet,
wherein at least said upper surface of said housing is constructed from a material adapted to admit electromagnetic radiation into said interior space of said housing, thereby heating said interior space of said housing,
and further wherein water contained within said interior space of said housing is vaporized by heat within said interior space of said housing and water vapor produced in said interior space of said housing exits said housing through said outlet.

2. The device according to claim 1 wherein said upper surface of said housing comprises three edges and said housing further comprises:
a first sidewall portion extending downward from a first edge of said upper surface of said housing portion;
a second sidewall portion extending downward from a second edge of said upper surface of said housing portion; and
a third sidewall portion extending downward from a third edge of said upper surface of said housing portion,
wherein said interior space of said housing is substantially enclosed by an upper surface of a body of water when said device is operably positioned within said body of water.

3. The device according to claim 1 wherein said housing is partially submerged in a body of water, the device further comprising a float portion attached to said housing for maintaining said device at a desired depth within said body of water.

4. The device according to claim 2 wherein said housing is partially submerged in said body of water, the device further comprising a float portion attached to said housing for maintaining said device at a desired depth within said body of water.

5. The device according to claim 1 further comprising a condenser portion in communication with said housing via said outlet, wherein water vapor exiting said housing via said outlet enters said condenser portion and is condensed.

6. The device according to claim 2 further comprising a condenser portion in communication with said housing via said outlet, wherein water vapor exiting said housing via said outlet enters said condenser portion and is condensed.

7. The device according to claim 1 further comprising a heating portion fixedly attached to an interior wall of said housing, said heating portion being in contact with at least a portion of said water contained within said housing for the purpose of heating said water.

8. The device according to claim 2 further comprising a heating portion fixedly attached to an interior wall of said housing, said heating portion being in contact with at least a portion of said body of water for the purpose of heating said portion of said body of water.

9. The device according to claim 1 wherein said housing further comprises an inlet, and further comprising a fan in fluid communication with said inlet for introducing air into said housing.

10. The device according to claim 1 further comprising a fan in fluid communication with said outlet for directed air and water vapor out of said housing.

11. The device according to claim 1 wherein said upper surface of said housing comprises four edges and said housing further comprises:
a first sidewall portion extending downward from a first edge of said upper surface of said housing portion;
a second sidewall portion extending downward from a second edge of said upper surface of said housing portion;
a third sidewall portion extending downward from a third edge of said upper surface of said housing portion;
a fourth sidewall portion extending downward from a fourth edge of said upper surface of said housing;
a bottom surface joining the bottom edges of each and said first, second, third, and fourth sidewall portions, said bottom portion having at least one bottom inlet for allowing water to enter said housing; and
a side inlet provided in at least one of said first, second, third, or fourth sidewall portions for allowing air into said housing,
wherein said outlet is provided in a sidewall of said housing other than the sidewall in which said inlet is provided.

12. The device according to claim wherein said side inlet and said outlet are provided in opposite sidewalls of said housing, and further wherein said sidewall of said housing providing said outlet has a greater height than said sidewall of said housing providing said side inlet, such that said housing forms a substantially wedge-like shape wherein water vapor within said housing tends naturally to flow to said outlet.

13. The device according to claim 12 further comprising a heating portion fixedly attached to an interior wall of said housing, said heating portion being in contact with at least a portion of said water contained within said housing for the purpose of heating said water.

14. The device according to claim 11 wherein said housing is partially submerged in a body of water, the device further comprising a float portion attached to said housing for maintaining said device at a desired depth within said body of water.

15. The device according to claim 11 further comprising a condenser portion in communication with said housing via said outlet, wherein water vapor exiting said housing via said outlet enters said condenser portion and is condensed.
